(19) United States
(12) Patent Application Publication
(10) Pub. No.: US 2026/0162288 A1
(43) Pub. Date: Jun. 11, 2026

(54) System and Method for Dimensioning Irregular Objects

(71) Applicant: Zebra Technologies Corporation, Lincolnshire, IL (US)

(72) Inventors: Raghavendra Tenkasi Shankar, Holbrook, NY (US); Michael Wijayantha Medagama, Nawala (LK); Patrick Bogan, Charlotte, NC (US); Ted D. Trask, Cary, NC (US)

(73) Assignee: Zebra Technologies Corporation, Lincolnshire, IL (US)

(21) Appl. No.: 19/285,982

(22) Filed: Jul. 30, 2025

Related U.S. Application Data
(60) Provisional application No. 63/729,844, filed on Dec. 9, 2024.

(51) Int. Cl. G06T 7/55

(52) U.S. Cl. CPC G06T 7/55; G06T 2210/12

(57) ABSTRACT

An example method includes: capturing first dimensioning data of a target object and a reference object from a first point of view; capturing second dimensioning data of the target and the reference object from a second point of view; correlating the reference object in the first dimensioning data and the reference object in the second dimensioning data to generate combined dimensioning data; determining a frame of reference for the combined dimensioning data based on the reference object; and determining at least one dimension of the target object using the combined dimensioning data and the frame of reference.

### CROSS-REFERENCE TO RELATED APPLICATIONS

This application claims priority to U.S. 63/729,844, filed Dec. 9, 2024 entitled “System and Method for Facilitating Dimensioning of Large Irregular Parcels”, the contents of which are incorporated herein by reference in its entirety.

### BACKGROUND

Determining the dimensions of objects may be necessary in a wide variety of applications. For example, it may be desirable to determine the dimensions of freight, parcels, packages in a warehouse prior to shipping or storage. Irregularly shaped objects may be difficult and time-consuming to dimension efficiently, as multiple angles of data may be required to accurately assess a frame of reference and common features of the irregularly-shaped object and determine dimensions of the object.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of an example system for dimensioning an irregular object.

FIG. 2 is a block diagram of certain internal hardware components of the dimensioning device of FIG. 1.

FIG. 3 is a flowchart of an example method for dimensioning irregular objects.

FIGS. 4A and 4B are schematic diagrams of first and second dimensioning data of the irregular object of FIG. 1.

FIG. 5 is a schematic diagram of combined dimensioning data of the irregular object of FIG. 1.

FIG. 6 is a flowchart of an example method for obtaining dimensions of the target object at block 330 of the method of FIG. 3.

FIG. 7 is a schematic diagram of a top view of the irregular object and application of bounding rectangles.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method comprising: capturing first dimensioning data of a target object and a reference object from a first point of view; capturing second dimensioning data of the target and the reference object from a second point of view; correlating the reference object in the first dimensioning data and the reference object in the second dimensioning data to generate combined dimensioning data; determining a frame of reference for the combined dimensioning data based on the reference object; and determining at least one dimension of the target object using the combined dimensioning data and the frame of reference.

Additional examples disclosed herein are directed to a device comprising: a sensor configured to capture dimensioning data representing a target object and a reference object; a processor interconnected with the sensor, the processor configured to: obtain, from the sensor, first dimensioning data of the target object and the reference object from a first point of view; obtain, from the sensor, second dimensioning data of the target and the reference object from a second point of view; correlate the reference object in the first dimensioning data and the reference object in the second dimensioning data to generate combined dimensioning data; determine a frame of reference for the combined dimensioning data based on the reference object; and determine at least one dimension of the target object using the combined dimensioning data and the frame of reference.

Additional examples disclosed herein are directed to a non-transitory computer-readable storage medium storing instructions thereon, which when executed by a processor configure the processor to: obtain first dimensioning data of a target object and a reference object from a first point of view; obtain second dimensioning data of the target object and the reference object from a second point of view; correlate the reference object in the first dimensioning data and the reference object in the second dimensioning data to generate combined dimensioning data; determine a frame of reference for the combined dimensioning data based on the reference object; and determine at least one dimension of the target object using the combined dimensioning data and the frame of reference.

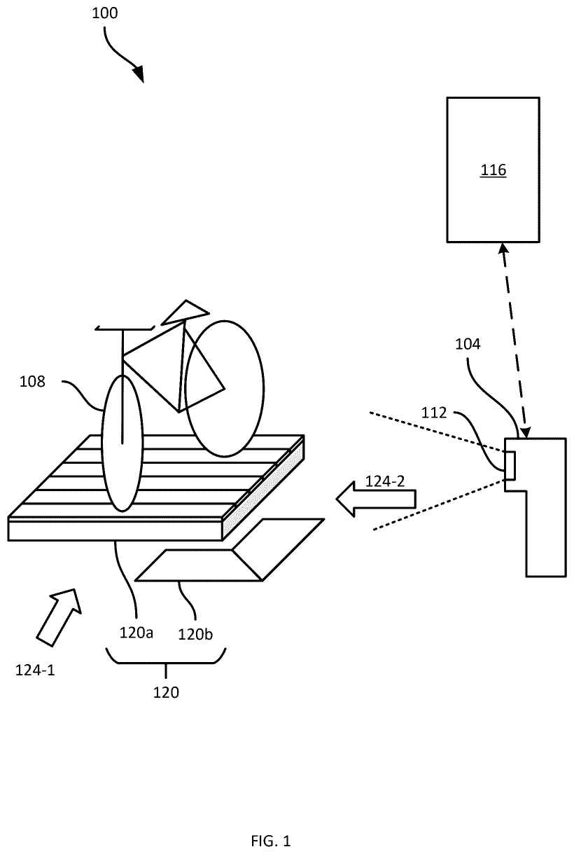

FIG. 1 depicts a system 100 for dimensioning irregular objects in accordance with the teachings of this disclosure. The system 100 includes a computing device 104 (also referred to herein as the dimensioning device 104 or simply the device 104) configured to dimension a target object 108. For example, the object 108 may be an item in a transport and logistics facility to be shipped or transported to another location. In some examples, the target object 108 may be irregularly shaped or substantially non-cuboidal.

The device 104 may be a mobile computing device, such as a mobile phone, a tablet, a barcode scanner, a dedicated dimensioning device, or the like. In such examples, the device 104 may include a sensor 112, a set of sensors, such as one or more depth sensors, one or more image sensors (e.g., optical cameras, infrared sensors, etc.) and the like to capture dimensioning data representing the object 108. In other examples, the device 104 may be a fixed computing device such as a desktop computer, a kiosk, or the like, and the device 104 may be associated with the sensor 112 to obtain data from the sensor 112 to dimension the object 108.

The device 104 may be in communication with a server 116 or other computing device via a communication link, illustrated in the present example as including wireless links. For example, the link may be provided by a wireless local area network (WLAN) deployed by one or more access points (not shown). In other examples, the server 116 is located remotely from the device 104 and the link may therefore include one or more wide-area networks such as the Internet, mobile networks, and the like. The server 116 may be any suitable server environment, including a plurality of cooperating servers operating, for example in a cloud-based environment.

The system 100 is generally deployed to dimension target objects, such as the object 108. In particular, the dimensioning device 104 is configured to dimension irregularly shaped objects. In some examples, irregularly shaped objects, such as the target object 108, may be dimensioned in conjunction with a pallet or skid 120a on which the object 108 is supported. In such examples, the target object 108 and the skid 120a form a single target palletized freight which is dimensioned as a whole. That is, the skid 120a serves as the base of the palletized freight and defines the origin and coordinate system by which the palletized freight is dimensioned.

In accordance with the present disclosure, the target object 108 may be dimensioned independently of the skid 120a which supports the target object 108. In particular, rather than dimensioning the target object 108 within the coordinate system of the skid 120a, as presently described, the dimensioning device 104 may use a reference object 120, to determine a frame of reference for the target object 108, allowing the target object 108 to be dimensioned more accurately. The reference object 120 may be, for example, the skid 120a having a predefined and/or standardized size or shape, or a marker 120b having a predefined shape, which may be placed and/or integrated into (e.g., painted onto) a floor or other support surface of the target object 108. In other examples, the reference object 120 may be another suitable object and/or marking having a predetermined shape and dimensions, with distinct features which may be recognizable in dimensioning data to allow the reference object 120 to be used as a common feature to correlate data sets.

In particular, at least first and second dimensioning data is obtained for the target object 108 and the reference object 120. The first and second dimensioning data is obtained from different points of view, such as a first point of view 124-1 and a second point of view 124-2, which in the present example are substantially perpendicular to one another. In other examples, the first and second points of view 124 may be at different angles relative to one another. Further, additional dimensioning data from additional points of view may also be obtained. The first and second dimensioning data may then be combined to generate combined dimensioning data based on cross-referencing the reference object 120 in both the first and second dimensioning data. The target object 108 may then be isolated in the combined dimensioning data to dimension the target object 108.

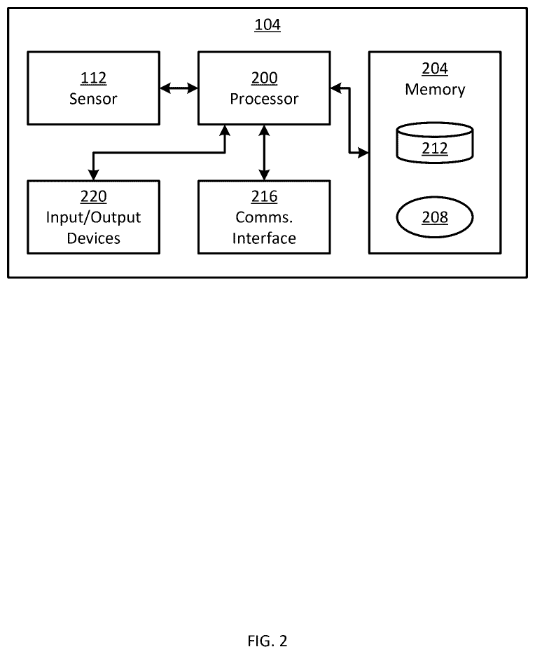

Turning now to FIG. 2, certain internal components of the dimensioning device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits.

The memory 204 stores computer-readable instructions for execution by the processor 200. In particular, the memory 204 stores an application 208 which, when executed by the processor, configures the processor 200 to perform various functions discussed below in greater detail and related to the dimensioning operation of the device 104. Some or all of the application 208 may also be implemented as a suite of distinct applications.

Those skilled in the art will appreciate that the functionality implemented by the processor 200 may also be implemented by one or more specially designed hardware and firmware components, such as a field-programmable gate array (FPGAs), application-specific integrated circuits (ASICs) and the like in other embodiments. In an embodiment, the processor 200 may be, respectively, a special purpose processor which may be implemented via dedicated logic circuitry of an ASIC, an FPGA, or the like in order to enhance the processing speed of the operations discussed herein. The memory 204 also stores a repository 212 storing rules and data for the dimensioning operation.

The device 104 may also include a communications interface 216 enabling the device 104 to exchange data with other computing devices such as the server 116. The communications interface 216 is interconnected with the processor 200 and includes suitable hardware (e.g. transmitters, receivers, network interface controllers and the like) allowing the device 104 to communicate with other computing devices—such as the server 116. The specific components of the communications interface 216 are selected based on the type of network or other links that the device 104 is to communicate over.

The device 104 may further include one or more input and/or output devices 220. The input devices 220 may include one or more buttons, keypads, touch-sensitive display screens or the like for receiving input from an operator. The output devices 220 may further include one or more display screens, sound generators, vibrators, or the like for providing output or feedback to an operator.

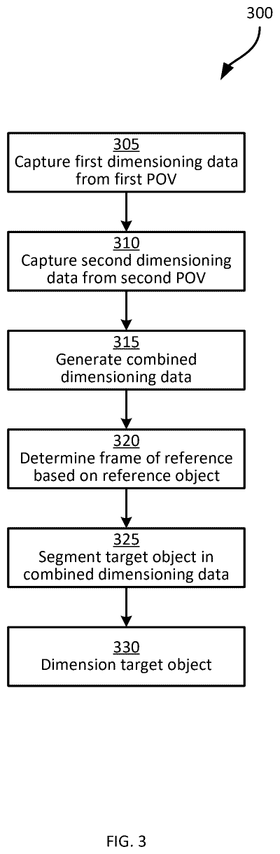

Turning now to FIG. 3, the functionality implemented by the device 104 will be discussed in greater detail. FIG. 3 illustrates a method 300 of dimensioning a target object. The method 300 will be discussed in conjunction with its performance in the system 100, and particularly by the device 104, via execution of the application 208. In particular, the method 300 will be described with reference to the components of FIGS. 1 and 2. In other examples, the method 300 may be performed by other suitable devices or systems.

The method 300 is initiated at block 305, where the device 104 captures first dimensioning data of the target object 108 and the reference object 120 from a first point of view. The first dimensioning data may be captured, for example from a first side of the skid 120a. In other examples, other angles and points of view may also be applied. In particular, the first dimensioning data may capture the reference object 120 and any key features thereof, such as the planks and/or gaps in the skid 120a, or the like. The first dimensioning data may include image and/or depth data captured by the sensor 112 for the dimensioning operation.

At block 310, the device 104 captures second dimensioning data of the target object 108 and the reference object 120 from a second point of view. The second dimensioning data may be captured, for example from a second side of the skid 120a, the second side being perpendicular to the first side of the skid 120a. In other examples, other angles and points of view may also be applied. In particular, the first and second points of view are different from one another. Preferably, the first and second points of view may capture different portions of the target object 108 to allow for increased accuracy in dimensioning the target object 108. The second dimensioning data may similarly include depth data and/or image data captured by the sensor 112 for the dimensioning operation.

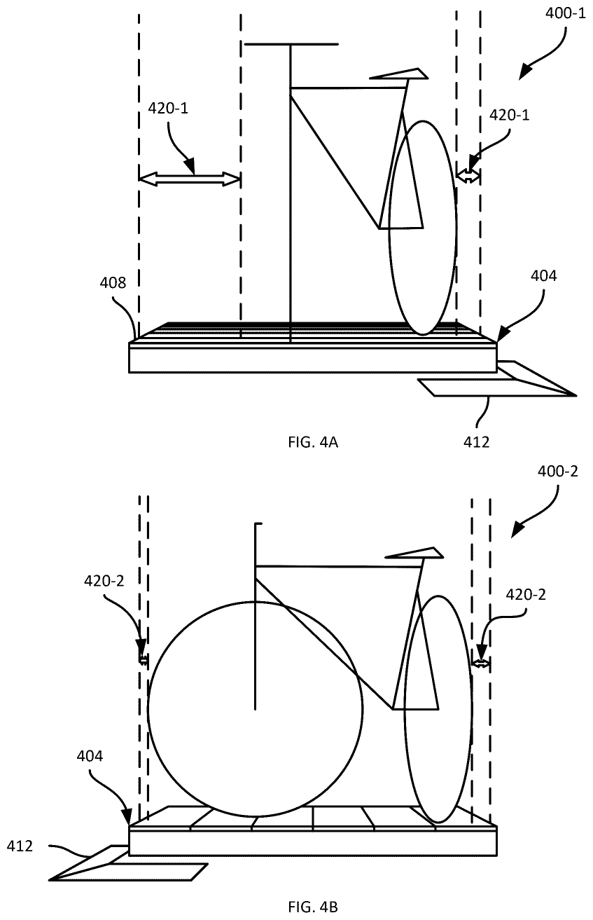

For example, referring to FIGS. 4A and 4B, example first dimensioning data 400-1 captured from the first point of view 124-1 is depicted and second dimensioning data 400-2 captured from the second point of view 124-2. In each point of view 124, different features and depths of the target object 108 can be captured by the device 104. In each point of view 124, the reference object 120 is also visible, and in particular, at least one common feature of the reference object 120, such as a corner 404 of the skid 120a, one or more slats 408 of the skid 120a, one or more legs and/or distinct shape portions 412 of the marker 120b, or the like. Further, in other examples, the first dimensioning data 400-1 and the second dimensioning data 400-2 may be perspective views or other angular views of the target object 108 and the reference object 120.

Returning to FIG. 3, at block 315, the device 104 generates combined dimensioning data from the first and second dimensioning data obtained at blocks 305 and 310. In particular, the device 104 may generate a point cloud representing the target object 108 and the reference object 120. The device 104 may use the detected common feature of the reference object 120 to correlate and/or map the first dimensioning data and the second dimensioning data to stitch the data together and generate the combined dimensioning data. For example, if both the first and second dimensioning data include depth data, the depth data from the different points of view may be combined based on the detected common feature to generate a more robust point cloud. If the first and second dimensioning data include image data, the image data captured from the different points of view may be combined as stereo images to generate a three-dimensional point cloud.

In other examples, rather than detecting a common feature of the reference object 120, the device 104 may detect a key feature of the reference object 120 which may be known and mapped onto the reference object 120. The first and second dimensioning data may be combined based on the mapping of the respective key feature of the reference object 120 detected in each point of view, according to a known and/or predefined shape or configuration of the reference object 120. For example, with respect to FIGS. 4A and 4B, the device 104 may identify the respective legs 412 of the marker 120b in each of the first and second dimensioning data 400.

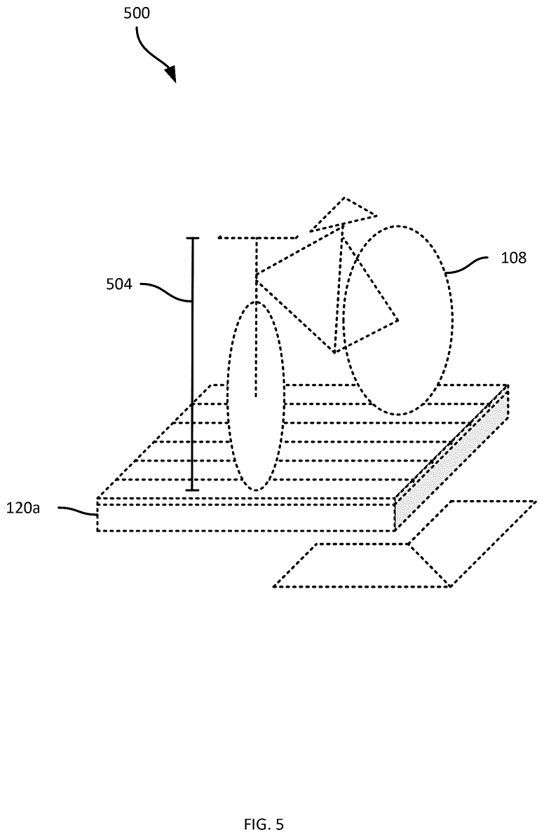

For example, referring to FIG. 5, example combined dimensioning data 500 combines the first dimensioning data 400-1 and the second dimensioning data 400-2 to obtain a point cloud representing the target object 108 and the reference object 120, including depth data pertaining to the different visible features of the target object 108 and the reference object 120 based on the cross-correlation of the reference object 120 as detected in both the first dimensioning data 400-1 and the second dimensioning data 400-2.

Returning again to FIG. 3, at block 320, the device 104 determines a frame of reference for the combined dimensioning data based on the reference object 120. For example, the device 104 may determine a dimension of the reference object 120 based on at least one of the combined dimensioning data, the first dimensioning data, and the second dimensioning data. For example, the skid 120a is substantially cuboidal, and hence another dimensioning operation may be employed to dimension the reference object 120. In other examples, the dimensions of the reference object 120 may be predetermined, for example according to a standard size of the skid 120a, or predetermined dimensions and shapes of the marker 120b.

The device 104 may map the obtained or determined dimensions of the reference object 120 onto the combined dimensioning data. The frame of reference may allow the device 104 to subsequently apply appropriate mappings to enable the dimensions of the target object 108 to be computed based on the combined dimensioning data. The reference object 120 may further define a support plane for the target object 108, based on the plane of a support surface on which the target object 108 is supported.

In some examples, determining the frame of reference may further include detecting margins of the target object 108 relative to the reference object 120. For example, referring again to FIG. 4A, the device 104 may determine margins 420-1 between the edges of the skid 120a and the outer edges of the target object 108 as supported on the skid 120a based on the first dimensioning data 400-1. Similarly, referring to FIG. 4B, the device 104 may determine margins 420-2 between the edges of the skid 120a and the corresponding outer edges of the target object 108 based on the second dimensioning data 400-2. The margins 420-1 and 420-2 may enable the device 104 to better segment the portion of the combined dimensioning data 500 pertaining to the target object 108 for the subsequent dimensioning operation.

At block 325 of the method 300, the device 104 is configured to segment the target object 108 in the combined dimensioning data. That is, the device 104 may identify portions of the combined dimensioning data corresponding to the target object 108, portions of the combined dimensioning data corresponding to the reference object 120, and portions of the combined dimensioning data corresponding to the surrounding environment. In some examples, the margins 420 determined at block 320 may facilitate the segmentation and differentiation of the target object 108 and the reference object 120.

After segmenting the combined dimensioning data, the device 104 is configured to extract or isolate the combined dimensioning data representing the target object 108.

At block 330, the device 104 is configured to determine one or more dimensions of the target object 108. For example, determining the dimensions of the target object 108 may include determining a bounding box, and preferably a minimum bounding box, which encloses the target object 108.

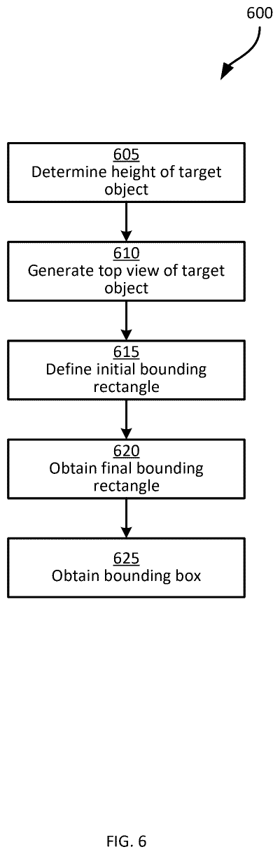

For example, referring to FIG. 6, an example method 600 of dimensioning the target object 108 is depicted.

At block 605, the device 104 is configured to determine a height of the target object 108. For example, the height of the target object 108 may be determined using the combined dimensioning data, the first dimensioning data and/or the second dimensioning data. In particular, based on the support surface and/or plane in the frame of reference determined at block 320 of the method 300, the device 104 may determine a maximum perpendicular distance of the target object 108 from the support surface as the height.

For example, referring to FIG. 5, the device 104 may use the combined dimensioning data to determine a height 504 of the target object 108, spanning a perpendicular distance from the support surface (i.e., in the present example, from a top surface of the skid 120a) to a maximum height of the target object 108.

Returning to FIG. 6, at block 610, the device 104 is configured to generate, using the combined dimensioning data, a top view of the target object 108. In particular, the device 104 may use the segmented portion of the combined dimensioning data corresponding to the target object 108 and excluding the reference object 120. In some examples, the device 104 may use the margins obtained as part of the frame of reference to determine at least some outer bounds of the top view of the target object 108.

At block 615, the device 104 may define an initial bounding rectangle for the target object 108 in the top view of the target object 108. For example, the device 104 may apply the margins detected based on the outer edges of the target object 108 in each of the first and second dimensioning data to generate the initial bounding rectangle, in particular, if the first and second points of view are substantially perpendicular to one another.

At block 620 the device 104 is configured to obtain a final bounding rectangle of the target object 108 using the top view of the target object 108. For example, the device 104 may apply a rotating calipers algorithm to the initial bounding rectangle in the top view of the target object 108 to obtain the final bounding rectangle for the target object 108. In particular, the initial bounding rectangle may be defined in the coordinate system of the reference object 120 (i.e., with edges parallel to the axes of the skid 120a or other coordinate system defined by the reference object 120). However, the target object 108 may not be aligned in the coordinate system of the reference object 120, and hence the final bounding rectangle may be object-oriented to be centered around the target object 108 itself, to minimally bound the target object 108. In accordance with the rotating calipers algorithm, a series of rectangles, rotating along the edges and vertices of the target object 108, may be sequentially tested to determine an area of each rectangle, until one rectangle is determined to have the smallest area of the series. This rectangle may be determined to be the final bounding rectangle and, having the smallest area, may minimally bound the target object 108. In other examples, the device 104 may apply other algorithms or processes to obtain the final bounding rectangle.

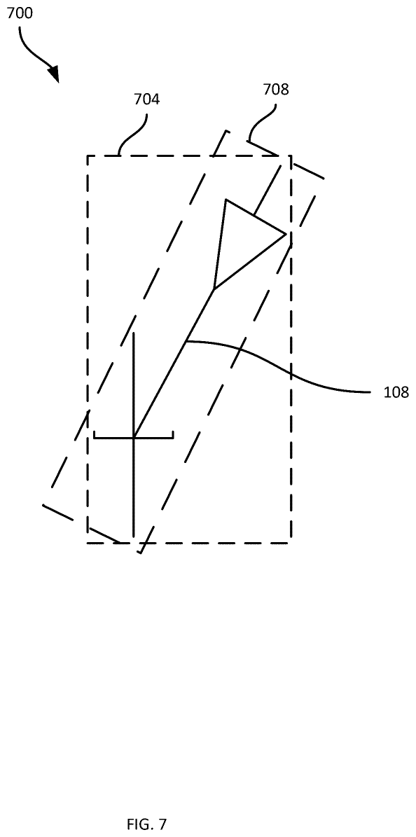

For example, referring to FIG. 7, an example top view 700 of the target object 108 is depicted. In particular, the top view 700 may exclude the dimensioning data corresponding to the reference object 120. The device 104 may generate an initial bounding rectangle 704 in line with the reference object 108, for example as determined based on the margins and/or the set of outer edges of the target object from at least one of the first dimensioning data, the second dimensioning data and the combined dimensioning data. The bounding rectangle 704 may be rotated about the top view of the target object 108 using the rotating calipers algorithm, until a final bounding rectangle 708 is identified having the minimum area of the bounding boxes tested by the rotating calipers algorithm.

Returning again to FIG. 6, at block 625, the final bounding rectangle and the height are combined to define the bounding box of the target object 108. The dimensions of the bounding box may be identified as the dimensions of the target object 108 and may be computed based on the frame of reference determined at block 320.

At block 330, the determined dimensions of the target object 108 may be output, for example at a display of the device 104, or transmitted to the server 116 or another computing device or the like. Further, in other examples, other mechanisms for determining the dimensions of the target object 108, determining a bounding box for the target object 108 or the like may also be applied.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method comprising:
capturing first dimensioning data of a target object and a reference object from a first point of view;
capturing second dimensioning data of the target object and the reference object from a second point of view;
correlating the reference object in the first dimensioning data and the reference object in the second dimensioning data to generate combined dimensioning data;
determining a frame of reference for the combined dimensioning data based on the reference object; and
determining at least one dimension of the target object using the combined dimensioning data and the frame of reference.

2. The method of claim 1, further comprising removing the reference object from the combined dimensioning data.

3. The method of claim 1, wherein determining the at least one dimension of the target object comprises determining a bounding box for the target object in the frame of reference.

4. The method of claim 3, wherein determining the bounding box comprises:
determining, based on at least one of the first dimensioning data, the second dimensioning data and the combined dimensioning data, a height of the bounding box based on a height of the target object from a support surface;
generating, using the combined dimensioning data, top view of the target object; and
determining, in the top view of the target object, a bounding rectangle for the target object.

5. The method of claim 4, wherein determining the bounding rectangle comprises:
detecting a set of outer edges of the target object from at least one of the first dimensioning data and the second dimensioning data;
applying the set of outer edges of the target object to the top view to generate an initial bounding rectangle; and
applying a rotating calipers algorithm to the initial bounding rectangle in the top view of the target object to obtain the bounding rectangle.

6. The method of claim 1, wherein the reference object comprises a pallet supporting the target object.

7. The method of claim 1, wherein the reference object comprises a marker having a predefined shape.

8. The method of claim 1, wherein the combined dimensioning data comprises a point cloud.

9. The method of claim 1, wherein correlating the reference object comprises:
detecting a common feature of the reference object in the first dimensioning data and the second dimensioning data; and
correlating the first dimensioning data and the second dimensioning data based on the detected common feature.

10. A device comprising:
a sensor configured to capture dimensioning data representing a target object and a reference object;
a processor interconnected with the sensor, the processor configured to:
obtain, from the sensor, first dimensioning data of the target object and the reference object from a first point of view;
obtain, from the sensor, second dimensioning data of the target object and the reference object from a second point of view;
correlate the reference object in the first dimensioning data and the reference object in the second dimensioning data to generate combined dimensioning data;
determine a frame of reference for the combined dimensioning data based on the reference object; and
determine at least one dimension of the target object using the combined dimensioning data and the frame of reference.

11. The device of claim 10, wherein the processor is further configured to remove the reference object from the combined dimensioning data.

12. The device of claim 10, wherein to determine the at least one dimension of the target object, the processor is configured to: determine a bounding box for the target object in the frame of reference.

13. The device of claim 12, wherein to determine the bounding box, the processor is configured to:
determine, based on at least one of the first dimensioning data, the second dimensioning data and the combined dimensioning data, a height of the bounding box based on a height of the target object from a support surface;
generate, using the combined dimensioning data, top view of the target object; and
determine, in the top view of the target object, a bounding rectangle for the target object.

14. The device of claim 13, wherein to determine the bounding rectangle, the processor is configured to:
detect a set of outer edges of the target object from at least one of the first dimensioning data and the second dimensioning data;
apply the set of outer edges of the target object to the top view to generate an initial bounding rectangle; and
apply a rotating calipers algorithm to the initial bounding rectangle in the top view of the target object to obtain the bounding rectangle.

15. The device of claim 10, wherein the reference object comprises a pallet supporting the target object.

16. The device of claim 10, wherein the reference object comprises a marker having a predefined shape.

17. The device of claim 10, wherein the combined dimensioning data comprises a point cloud.

18. The device of claim 10, wherein to correlate the reference object, the processor is configured to:
detect a common feature of the reference object in the first dimensioning data and the second dimensioning data; and
correlate the first dimensioning data and the second dimensioning data based on the detected common feature.

19. A non-transitory computer-readable storage medium storing instructions thereon, which when executed by a processor configure the processor to:
obtain first dimensioning data of a target object and a reference object from a first point of view;
obtain second dimensioning data of the target object and the reference object from a second point of view;
correlate the reference object in the first dimensioning data and the reference object in the second dimensioning data to generate combined dimensioning data;
determine a frame of reference for the combined dimensioning data based on the reference object; and
determine at least one dimension of the target object using the combined dimensioning data and the frame of reference.

20. The non-transitory computer-readable storage medium of claim 19, wherein execution of the instructions further configure the processor to:
determine, based on at least one of the first dimensioning data, the second dimensioning data and the combined dimensioning data, a height of a bounding box for the target object based on a height of the target object from a support surface;
generate, using the combined dimensioning data, top view of the target object; and
determine, in the top view of the target object, a bounding rectangle for the target object.
